(19) United States
(12) Patent Application Publication
(10) Pub. No.: US 2014/0207902 A1
(43) Pub. Date: Jul. 24, 2014

(54) SYSTEMS AND METHODS FOR OUT-OF-BAND MANAGEMENT OF AN INFORMATION HANDLING SYSTEM

(71) Applicant: DELL PRODUCTS L.P., Round Rock, TX (US)

(72) Inventors: Anand Joshi, Round Rock, TX (US); Carlton Andrews, Austin, TX (US); Christopher Ramirez, Leander, TX (US)

(73) Assignee: DELL PRODUCTS L.P., Round Rock, TX (US)

(21) Appl. No.: 13/747,981

(22) Filed: Jan. 23, 2013

(51) Int. Cl. H04L 29/08

(52) U.S. Cl. CPC H04L 67/02
USPC 709/217

(57) ABSTRACT

Instructions embodied in a basic input/output system may cause a processor to, when read and executed by the processor communicate a query via a network interface to an intermediate information handling system to determine if digital assets intended for the information handling system were previously communicated from a management server to the intermediate information handling system and in response to a determination that digital assets intended for the information handling system were previously communicated from a management server to the intermediate information handling system, receive the digital assets at the information handling system from the intermediate information handling system.

### TECHNICAL FIELD

The present disclosure relates in general to information handling systems, and more particularly to out-of-band management of an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Client management of an information handling system, in which an information handling system known as a client is managed by another information handling system communicatively coupled to the client via a network and known as a management server, is becoming increasingly commonplace. Traditionally, client management is conducted in one of two ways. The first is “in-band” management, in which the management server manages the client while the client is powered on, fully booted, and executing an operating system. The second is “out-of-band” management, in which the management server undertakes remote monitoring and management regardless of whether the client information handling system is powered on and/or has an operating system executing or even installed thereon. To perform out-of-band management, traditional approaches require that special hardware known as a service processor be installed within the client information handling system. The service processor requires a source of electrical power (e.g., a battery or a power source engaged with a power outlet), but may communicate with the management server via a management channel physically isolated from an in-band communication channel present when an operating system is executing on the client information handling system. Thus, for example, if a failure occurs in the client information handling system that prevents an administrator from remotely accessing the client information handling system via its traditional network interface (e.g., operating system failure, power failure, etc.), the administrator may still be able to monitor and/or manage the client information handling system (e.g., to diagnose problems that may have caused failure) via the service processor. A service processor may allow an administrator to remotely manage one or more parameters associated with operation of the client information handling system (e.g., power usage, processor allocation, memory allocation, security privileges, etc.) and/or communicate updates and patches to the client information handling system (e.g., Basic Input/Output System updates, driver updates, etc.). Such a service processor may include or may be an integral part of an access controller, baseboard management controller (BMC), Dell Remote Access Controller (DRAC) or an Integrated Dell Remote Access Controller (iDRAC).

Despite the utility of in-band and out-of-band management, traditional approaches to each have disadvantages. A disadvantage of in-band management lies in that it requires a functional operating system to be executing on the client information handling system, which limits the ability to manage when the operating system is not executing or is corrupted. A disadvantage of out-of-band management is that it requires a service processor or similar hardware, which may add undesired cost to the client information handling system. In addition, traditional out-of-band management may not be suitable for use with portable information handling systems (e.g., laptop computers, notebook computers, tablets, etc.) as such portable information handling systems may often not be attached to a power supply, thus requiring use of a battery, and leaving a service processor running while the portable information handling system is not otherwise being used may quickly drain such battery.

### SUMMARY

In accordance with the teachings of the present disclosure, the disadvantages and problems associated with client management of an information handling resource have been reduced or eliminated.

In accordance with embodiments of the present disclosure, an information handling system may include a processor, a network interface communicatively coupled to the processor, and a basic input/output system comprising one or more instructions embodied in computer-readable media communicatively coupled to the processor. The instructions may cause the processor to, when read and executed by the processor communicate a query via the network interface to an intermediate information handling system to determine if digital assets intended for the information handling system were previously communicated from a management server to the intermediate information handling system and in response to a determination that digital assets intended for the information handling system were previously communicated from a management server to the intermediate information handling system, receive the digital assets at the information handling system from the intermediate information handling system.

In accordance with these and other embodiments of the present disclosure, a method may include during execution of a basic input/output system of a client information handling system, communicating a query from the client information handling system to an intermediate information handling system via a network interface of the client information handling system to determine if digital assets intended for the client information handling system were previously communicated from a management server to the intermediate information handling system. The method may further include, in response to a determination that digital assets intended for the client information handling system were previously communicated from a management server to the intermediate information handling system, receiving the digital assets at the client information handling system from the intermediate information handling system.

In accordance with these and other embodiments of the present disclosure, an information handling system may include a processor, a network interface communicatively coupled to the processor, and a program of one or instructions embodied in computer-readable media communicatively coupled to the processor. The instructions may cause the processor to, when read and executed by the processor: (i) receive a query via the network interface from a client information handling system; (ii) in response to the query, determine if digital assets intended for the client information handling system were previously communicated from a management server to the information handling system; and (iii) in response to a determination that digital assets intended for the client information handling system were previously communicated from the management server to the information handling system, communicate the digital assets from the information handling system to the client information handling system.

In accordance with these and other embodiments of the present disclosure, a method may include receiving a query via a network interface of an intermediate information handling system from a client information handling system. The method may also include, in response to the query, determining if digital assets intended for the client information handling system were previously communicated from a management server to the intermediate information handling system. The method may further include, in response to a determination that digital assets intended for the client information handling system were previously communicated from the management server to the intermediate information handling system, communicating the digital assets from the intermediate information handling system to the client information handling system.

Technical advantages of the present disclosure will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system for management of an information handling system, in accordance with certain embodiments of the present disclosure; and

FIG. 2 illustrates a flow chart of an example method for client management of an information handling system, in accordance with certain embodiments of the present disclosure.

### DETAILED DESCRIPTION

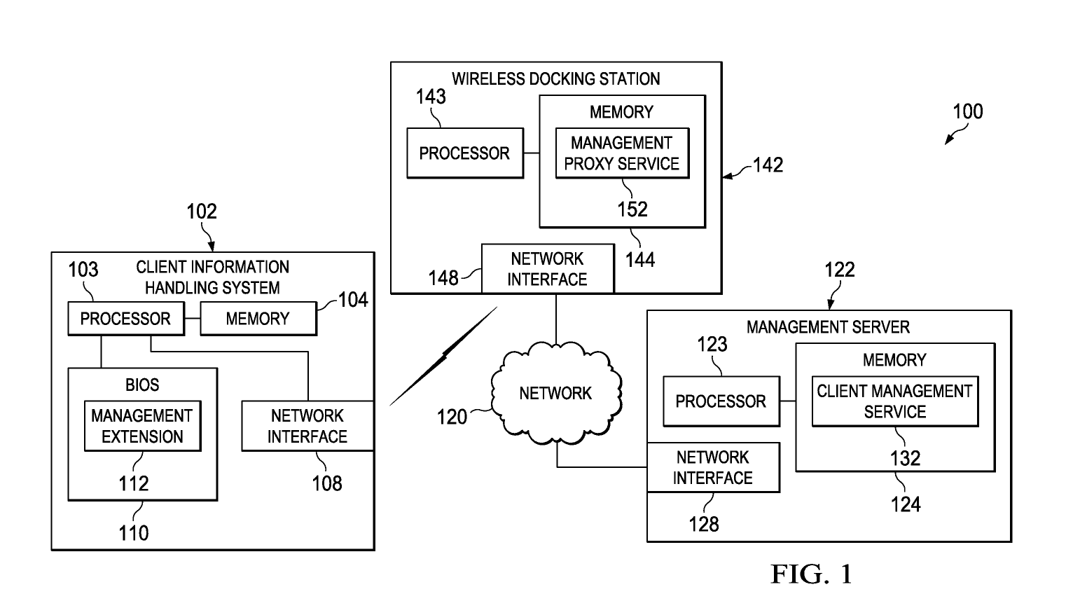

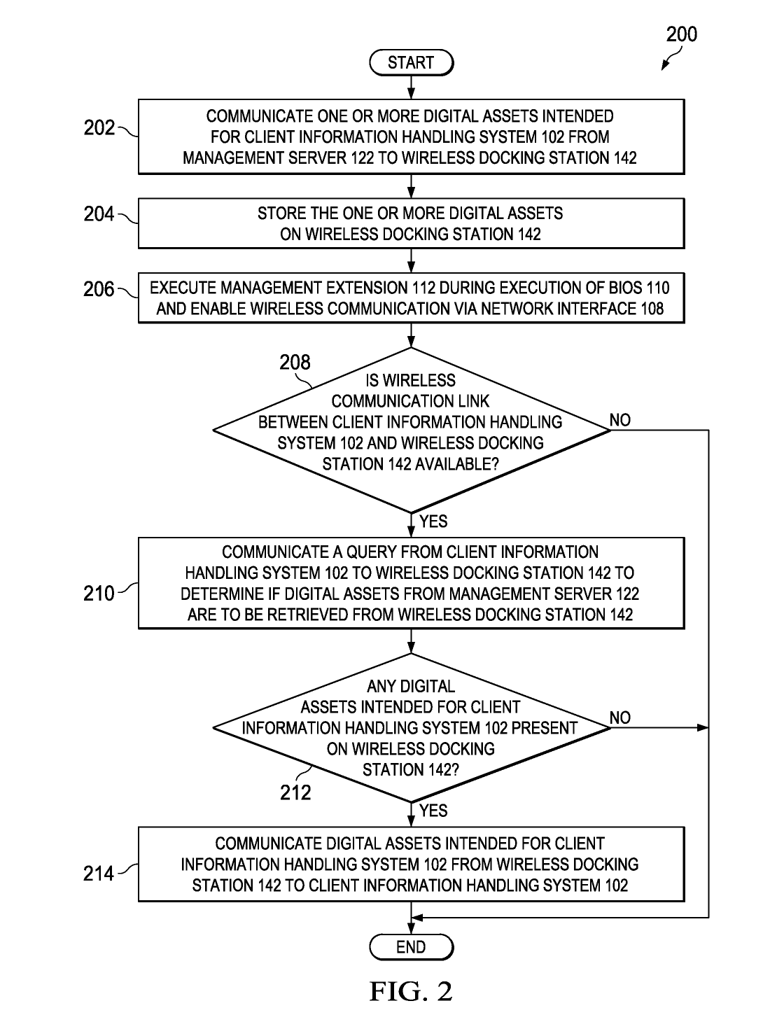

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more busses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, busses, memories, I/O devices and/or interfaces, storage resources, network interfaces, motherboards, and/or any other components and/or elements of an information handling system.

For the purposes of this disclosure, a digital asset may broadly refer to any software application, deliverable or performable service (e.g., one or more commands or instructions), music, video, software activation key, personalization instructions, files, management data, configuration data, or other digital media that is digitally deliverable either wholly or partially.

The terms “wireless transmissions” and “wireless communication” may be used to refer to all types of electromagnetic communications which do not require a wire, cable, or other types of conduits. Examples of wireless transmissions which may be used include, but are not limited to, short-range wireless communication technologies (e.g., proximity card, Radio-Frequency Identification (RFID), Near Field Communication (NFC), BLUETOOTH, ISO 14443, ISO 15693, or other suitable standard), personal area networks (PAN) (e.g., BLUETOOTH), local area networks (LAN), wide area networks (WAN), narrowband personal communications services (PCS), broadband PCS, circuit switched cellular, cellular digital packet data (CDPD), radio frequencies, such as the 800 MHz, 900 MHz, 1.9 GHz and 2.4 GHz bands, infra-red and laser.

For the purpose of this disclosure, “short-range wireless communications technology” refers to any suitable communications transport, protocol, and/or standard allowing two or more suitably-configured devices to communicate via wireless transmissions provided that such devices are within approximately one meter of each other. Examples of short-range communications technologies include, without limitation, BLUETOOTH Class 3, near field communication (NFC), radio frequency identification (RFID), proximity card, vicinity card, ISO 14443, and ISO 15693.

The term “wire-line transmissions” may be used to refer to all types of electromagnetic communications over wires, cables, or other types of conduits. Examples of such conduits include, but are not limited to, metal wires and cables made of copper or aluminum, fiber-optic lines, and cables constructed of other metals or composite materials satisfactory for carrying electromagnetic signals. Wire-line transmissions may be conducted in accordance with teachings of the present disclosure over electrical power lines, electrical power distribution systems, building electrical wiring, conventional telephone lines, Ethernet cabling (10baseT, 100baseT, etc.), coaxial cables, T-1 lines, T-3 lines, ISDN lines, ADSL, etc.

FIG. 1 illustrates a block diagram of an example system for management of a client information handling system 102, in accordance with certain embodiments of the present disclosure. As shown in FIG. 1, system 100 may include a client information handling system 102 and a management server 122. In some embodiments, client information handling system 102, management server 122, a wireless docking station 142, and a network 120 communicatively coupling management server 122 to wireless docking station 142.

In some embodiments, client information handling system 102 may be a personal computer. In particular embodiments, client information handling system 102 may be a portable information handling system (e.g., a laptop, notebook, tablet, handheld, smart phone, personal digital assistant, etc.). As depicted in FIG. 1, client information handling system 102 may include a processor 103, a memory 104 communicatively coupled to processor 103, a network interface 108 communicatively coupled to processor 103, and a basic input/output system (BIOS) 110 communicatively coupled to processor 103.

Processor 103 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, BIOS 110, and/or another component of client information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to client information handling system 102 is turned off.

Network interface 108 may comprise any suitable system, apparatus, or device operable to serve as an interface between client information handling system 102 and another information handling system and/or a network. Network interface 108 may enable client information handling system 102 to communicate using any suitable transmission protocol and/or standard. In some embodiments, network interface 108 may be configured to communicate with network interface 148 of wireless docking station 142 via wireless transmissions. In particular embodiments, network interface 108 may be configured to communicate with network interface 148 of wireless docking station 142 via a short-range wireless communications technology. In these and other embodiments, network interface 108 may comprise a network interface card, or “NIC.”

BIOS 110 may be communicatively coupled to processor 103 and may include any system, device, or apparatus configured to identify, test, and/or initialize information handling resources of client information handling system 102. “BIOS” may broadly refer to any system, device, or apparatus configured to perform such functionality, including without limitation, a Unified Extensible Firmware Interface (UEFI). In some embodiments, BIOS 110 may be implemented as a program of instructions that may be read by and executed on processor 103 to carry out the functionality of BIOS 110. In these and other embodiments, BIOS 110 may comprise boot firmware configured to be the first code executed by processor 103 when client information handling system 102 is booted and/or powered on. As part of its initialization functionality, BIOS code may be configured to set components of client information handling system 102 into a known state, so that one or more applications (e.g., an operating system or other application programs) stored on compatible media (e.g., memory 104) may be executed by processor 103 and given control of client information handling system 102.

As shown in FIG. 1, BIOS 110 may include management extension 112. As described in greater detail elsewhere in this disclosure, management extension 112 may include any system, device, or apparatus configured to, during execution of BIOS 110, retrieve one or more digital assets from wireless docking station 142. In some embodiments, management extension 112 may be implemented as a program of instructions that may be read by and executed on processor 103 to carry out the functionality of management extension 112. In embodiments in which BIOS 110 comprises a UEFI, management extension may comprise a UEFI extension.

In addition to processor 103, memory 104, network interface 108, and BIOS 110, client information handling system 102 may include one or more other information handling resources.

Network 120 may be a network and/or fabric configured to couple management server 122 and wireless docking station 142 to each other and/or one or more other information handling systems. In some embodiments, network 120 may also, via network interface 148 of wireless docking station 142, couple client information handling system 102 to management server 122 and/or one or more other information handling systems. In these and other embodiments, network 120 may include a communication infrastructure, which provides physical connections, and a management layer, which organizes the physical connections and information handling systems communicatively coupled to network 120. Network 120 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 120 may transmit data via wireless transmissions and/or wire-line transmissions using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 120 and its various components may be implemented using hardware, software, or any combination thereof.

In some embodiments, management server 122 may be a server. In other embodiments, management server 122 may be a personal computer (e.g., a desktop computer or a portable computer). As depicted in FIG. 1, management server 122 may include a processor 123, a memory 124 communicatively coupled to processor 123, and a network interface 128 communicatively coupled to processor 123.

Processor 123 may include any system, device, or apparatus configured to interpret and/or execute program instructions and/or process data, and may include, without limitation a microprocessor, microcontroller, DSP, ASIC, or any other digital or analog circuitry configured to interpret and/or execute program instructions and/or process data. In some embodiments, processor 123 may interpret and/or execute program instructions and/or process data stored in memory 124 and/or another component of management server 122.

Memory 124 may be communicatively coupled to processor 123 and may include any system, device, or apparatus configured to retain program instructions and/or data for a period of time (e.g., computer-readable media). Memory 124 may include RAM, EEPROM, a PCMCIA card, flash memory, magnetic storage, opto-magnetic storage, or any suitable selection and/or array of volatile or non-volatile memory that retains data after power to management server 122 is turned off.

As shown in FIG. 1, memory 124 may have stored thereon client management service 132. Client management service 132 may include any system, device, or apparatus configured to, as described in greater detail elsewhere in this disclosure, manage client information handling system 102 by communicating digital assets to wireless docking station 142. In some embodiments, client management service 132 may be implemented as a program of instructions that may be read by and executed on processor 123 to carry out the functionality of client management service 132.

Network interface 128 may comprise any suitable system, apparatus, or device operable to serve as an interface between management server 122 and network 120. Network interface 128 may enable management server 122 to communicate using any suitable transmission protocol and/or standard, including any of the protocols and/or standards described above with respect to network 120. In these and other embodiments, network interface 128 may comprise a NIC.

In addition to processor 123, memory 124, and network interface 128, management server 122 may include one or more other information handling resources.

Wireless docking station 142 may comprise a docking station, port replicator, or dock that allows client information handling system 102 or another electronic device to communicatively couple to peripherals and/or network devices communicatively coupled to wireless docking station 142. As its name indicates, wireless docking station 142 allows client information handling system 102 to communicatively couple to wireless docking station 142 (and thus the devices communicatively coupled to wireless docking station 142) via wireless transmissions communicated between network interface 108 and network interface 148. In some embodiments, wireless docking station 142 may comprise an information handling system, albeit with functionality and/or structure different than that of client information handling system 102 and/or management server 122. As depicted in FIG. 1, wireless docking station 142 may include a processor 143, a memory 144 communicatively coupled to processor 143, and a network interface 148 communicatively coupled to processor 143.

Processor 143 may include any system, device, or apparatus configured to interpret and/or execute program instructions and/or process data, and may include, without limitation a microprocessor, microcontroller, DSP, ASIC, or any other digital or analog circuitry configured to interpret and/or execute program instructions and/or process data. In some embodiments, processor 143 may interpret and/or execute program instructions and/or process data stored in memory 144 and/or another component of wireless docking station 142.

Memory 144 may be communicatively coupled to processor 143 and may include any system, device, or apparatus configured to retain program instructions and/or data for a period of time (e.g., computer-readable media). Memory 144 may include RAM, EEPROM, a PCMCIA card, flash memory, magnetic storage, opto-magnetic storage, or any suitable selection and/or array of volatile or non-volatile memory that retains data after power to wireless docking station 142 is turned off.

As shown in FIG. 1, memory 144 may have stored thereon management proxy service 152. Management proxy service 152 may include any system, device, or apparatus configured to, as described in greater detail elsewhere in this disclosure, coordinate management by management server 122 of client information handling system 102 by receiving one or more digital assets from management server 122 and communicating such digital assets to client information handling system 102. In some embodiments, management proxy service 152 may be implemented as a program of instructions that may be read by and executed on processor 143 to carry out the functionality of management proxy service 152.

Network interface 148 may comprise any suitable system, apparatus, or device operable to serve as an interface between wireless docking station 142 and network 120, and/or serve as an interface between wireless docking station 142 and another information handling system and/or a network. Network interface 148 may enable wireless docking station 142 to communicate using any suitable transmission protocol and/or standard, including any of the protocols and/or standards described above with respect to network 120. In some embodiments, network interface 148 may be configured to communicate with network interface 108 of client information handling system 102 via wireless transmissions. In particular embodiments, network interface 148 may be configured to communicate with network interface 108 of client information handling system 102 via a short-range wireless communications technology. In these and other embodiments, network interface 148 may comprise a NIC.

In addition to processor 143, memory 144, and network interface 148, wireless docking station 142 may include one or more other information handling resources.

In operation, client management service 132 may communicate one or more digital assets intended for client information handling system 102 to wireless docking station 142. Management proxy service 152 may store the one or more digital assets to memory 144 or other suitable computer-readable media integral to or associated with wireless docking station 142. Such communication and receipt of the one or more digital assets may occur whether or not client information handling system 102 is within sufficient proximity to communicate with wireless docking station 142.

During execution of BIOS 110 (e.g., upon system start-up or boot of client information handling system 102), management extension 112 may execute. Management extension 112 may enable wireless communication via network interface 108 and determine if a wireless communication link with wireless docking station 142 is available, which may be the case if client information handling system 102 is within sufficient proximity to communicate with wireless docking station 142 via wireless transmissions. If a wireless communication link is available, management extension 112 may communicate a query to wireless docking station 142 to determine if digital assets from management server 122 are to be retrieved from wireless docking station 142. In response to the query, management proxy service 152 may determine if any digital assets intended for client information handling system 102 are present on wireless docking station 142 and if so, management proxy service 152 may communicate such digital assets to client information handling system 102.

In some embodiments, the digital assets communicated to client information handling system 102 may comprise commands or instructions, which management extension 112 may respond to by further communication with wireless docking station 142, management server 122, and/or another information handling system communicatively coupled to client information handling system 102. As a specific example, such commands or instructions may include an instruction to client information handling system 102 to download particular files, and client information handling system 102 may respond by contacting management server 122 and/or another information handling system communicatively coupled to client information handling system 102 in order to download such files.

In these and other embodiments, the digital assets communicated to client information handling system 102 may comprise files comprising software programs, and management extension 112 may respond to such receipt of files by installing and/or executing such files.

Although FIG. 1 depicts wireless docking station 142 having management proxy service 152 configured to carry out out-of-band communication between management server 122 and client information handling system 102, it is understood that any suitable intermediary information handling system (e.g., network switch, router, wired docking station, etc.) capable of executing management proxy service 152 may be used in place of wireless docking station 142 depicted in FIG. 1. In addition, any such intermediary information handling system may, instead of or in additional to being communicatively coupled to client information handling system 102 via wireless transmissions, be communicatively coupled to client information handling system via a wired connection (e.g., Universal Serial Bus, Serial Advanced Technology Attachment, or any other suitable wired standard or protocol whether or not presently known).

FIG. 2 illustrates a flow chart of an example method 200 for client management of client information handling system 102, in accordance with certain embodiments of the present disclosure. According to one embodiment, method 200 may begin at step 202. As noted above, teachings of the present disclosure may be implemented in a variety of configurations of system 100. As such, the preferred initialization point for method 200 and the order of the steps comprising method 200 may depend on the implementation chosen.

At step 202, client management service may communicate one or more digital assets intended for client information handling system 102 to wireless docking station 142.

At step 204, in response to receipt of the one or more digital assets, management proxy service 152 may store the one or more digital assets to memory 144 or other suitable computer-readable media integral to or associated with wireless docking station 142. Such communication and receipt of the one or more digital assets may occur whether or not client information handling system 102 is within sufficient proximity to communicate with wireless docking station 142.

At step 206, during execution of BIOS 110 (e.g., upon system start-up or boot of client information handling system 102), management extension 112 may execute. During such execution, management extension 112 may enable wireless communication via network interface 108.

At step 208, management extension 112 may determine if a wireless communication link with wireless docking station 142 is available, which may be the case if client information handling system 102 is within sufficient proximity to communicate with wireless docking station 142 via wireless transmissions. If a wireless communication link is available, method 200 may proceed to step 210. Otherwise, method 200 may end.

At step 210, in response to a determination that a wireless communication link is available between client information handling system 102 and wireless docking station 142, management extension 112 may communicate a query to wireless docking station 142 to determine if digital assets from management server 122 are to be retrieved from wireless docking station 142.

At step 212, in response to the query, management proxy service 152 may determine if any digital assets intended for client information handling system 102 are present on wireless docking station 142. If it is determined that any digital assets intended for client information handling system 102 are present on wireless docking station 142, method 200 may proceed to step 214. Otherwise, method 200 may end.

At step 214, in response to a determination that any digital assets intended for client information handling system 102 are present on wireless docking station 142, management proxy service 152 may communicate digital assets intended for client information handling system 102 to client information handling system 102. After completion of step 214, method 200 may end.

Although FIG. 2 discloses a particular number of steps to be taken with respect to method 200, method 200 may be executed with greater or lesser steps than those depicted in FIG. 2. In addition, although FIG. 2 discloses a certain order of steps to be taken with respect to method 200, the steps comprising method 200 may be completed in any suitable order.

Method 200 may be implemented using system 100 or any other system operable to implement method 200. In certain embodiments, method 200 may be implemented partially or fully in software and/or firmware embodied in computer-readable media.

Although the present disclosure has been described in detail, it should be understood that various changes, substitutions, and alterations can be made hereto without departing from the spirit and the scope of the disclosure as defined by the appended claims.

What is claimed is:

1. An information handling system comprising:
a processor;
a network interface communicatively coupled to the processor; and
a basic input/output system comprising one or more instructions embodied in computer-readable media communicatively coupled to the processor, the instructions for causing the processor to, when read and executed by the processor:
communicate a query via the network interface to an intermediate information handling system to determine if digital assets intended for the information handling system were previously communicated from a management server to the intermediate information handling system; and
in response to a determination that digital assets intended for the information handling system were previously communicated from a management server to the intermediate information handling system, receive the digital assets at the information handling system from the intermediate information handling system.

2. The information handling system of claim 1, wherein the intermediate information handling system comprises a wireless docking station.

3. The information handling system of claim 1, wherein communicating the query via the network interface comprises communicating the query via wireless transmissions.

4. The information handling system of claim 1, the instructions for further causing the processor to:
enable wireless communication via the network interface;
determine if a wireless communication link exists between the information handling system and the intermediate information handling system; and
communicate the query via the network interface in response to determining that a wireless communication link exists between the information handling system and the intermediate information handling system.

5. The information handling system of claim 1, wherein the basic input/output system comprises a Unified Extensible Firmware Interface.

6. The information handling system of claim 5, wherein the one or more instructions are integral to a Unified Extensible Firmware Interface extension.

7. A method comprising:
during execution of a basic input/output system of a client information handling system, communicating a query from the client information handling system to an intermediate information handling system via a network interface of the client information handling system to determine if digital assets intended for the client information handling system were previously communicated from a management server to the intermediate information handling system; and
in response to a determination that digital assets intended for the client information handling system were previously communicated from a management server to the intermediate information handling system, receiving the digital assets at the client information handling system from the intermediate information handling system.

8. The method of claim 7, wherein the intermediate information handling system comprises a wireless docking station.

9. The method of claim 7, wherein communicating the query via the network interface comprises communicating the query via wireless transmissions.

10. The method of claim 7, further comprising:
enabling wireless communication via the network interface during execution of the basic input/output system;
determining if a wireless communication link exists between the information handling system and the intermediate information handling system; and
communicating the query via the network interface in response to determining that a wireless communication link exists between the information handling system and the intermediate information handling system.

11. An information handling system comprising:
a processor;
a network interface communicatively coupled to the processor; and
a program of one or instructions embodied in computer-readable media communicatively coupled to the processor, the instructions for causing the processor to, when read and executed by the processor:
receive a query via the network interface from a client information handling system;
in response to the query, determine if digital assets intended for the client information handling system were previously communicated from a management server to the information handling system; and
in response to a determination that digital assets intended for the client information handling system were previously communicated from the management server to the information handling system, communicate the digital assets from the information handling system to the client information handling system.

12. The information handling system of claim 11, the instructions for further causing the processor to, prior to receipt of the query, store, on the information handling system, the one or more digital assets received via the network interface from the management server.

13. The information handling system of claim 11, wherein the information handling system comprises a wireless docking station.

14. The information handling system of claim 11, wherein receiving the query via the network interface comprises receiving the query via wireless transmissions.

15. A method comprising:
receiving a query via a network interface of an intermediate information handling system from a client information handling system;
in response to the query, determining if digital assets intended for the client information handling system were previously communicated from a management server to the intermediate information handling system; and
in response to a determination that digital assets intended for the client information handling system were previously communicated from the management server to the intermediate information handling system, communicating the digital assets from the intermediate information handling system to the client information handling system.

16. The method of claim 15, further comprising, prior to receipt of the query, storing, on the intermediate information handling system, the one or more digital assets received via the network interface from the management server.

17. The method of claim 15, wherein the intermediate information handling system comprises a wireless docking station.

18. The method of claim 15, wherein receiving the query via the network interface comprises receiving the query via wireless transmissions.
